(19) United States
(12) Patent Application Publication
(10) Pub. No.: US 2005/0268111 A1
(43) Pub. Date: Dec. 1, 2005

(54) Authenticating wireless phone system

(76) Inventor: Thomas R. Markham, Anoka, MN (US)

Correspondence Address: Kris T. Fredrick;Patent Services, Honeywell International Inc., 101 Columbia Road, Morristown, NJ, 07962, US

(21) Appl. No.: 10/846,388

(22) Filed: May 13, 2004

(51) Int. Cl. H04K 1/00

(52) U.S. Cl. 713/186

(57) ABSTRACT

An authenticating portable electronic device such as a cellular phone having radio frequency transmission capability, battery power and a keypad. The device further includes a fingerprint reader proximate the keypad of the device for authenticating the user of the device, as well as a transreceiver in the device for communicating authentication signals with a remote location to verify the identity of the user. Remote locations may be gates, doors or badge screening locations. Also included is a transmitter for sending signals to a transceiver receiver having a connection to a wire telephone system within a structure to permit phone calls using the device through the receiver to and from the wire telephone system. The device includes a connector for connecting to a docking cradle operably connected to a computer for authenticating the user before allowing access to the computer, which can also be the battery charging interface.

### FIELD OF THE INVENTION

The present invention relates in general to and wireless phone security, and more particularly, to a system for authenticating a variety of uses for wireless phones.

### BACKGROUND OF THE INVENTION

The use of cellular or wireless telephones has expanded over the last few years so extensively that cellular phones are threatening to replace conventional wire telephones. These phones have a number of features, such as internet connection, video transmission, games, ring tones, fingerprint biometrics, calendar and calculators, text messaging, caller identification, and the like. Wireless phones are also being used by some business and technical personnel as part of the work-day operation.

At the same time, commercial, government and military facilities are increasingly concerned about security and now require some means for authenticating users to computer, badge readers, and other identity management/access control systems. Users currently have multiple devices and technique for authentication. Employers must maintain multiple systems. This is expensive, inconvenient and may be error prone.

Because commercial, government and military organizations require a plurality of authentication methods as well as other functions, two or more data base systems are required, which plurality of data systems is expensive, duplicative, and not always properly matched for completeness. Another advantage in operation of these entities would accrue if multiple systems could be combined into one.

Most, if not all, cell phones and PDAs are designed as consumer items, and are not well integrated into an organizational infrastructure. It would be of great advantage in the art if an improved wireless phone could be developed that eliminated the use of other devices such as identification badges and the like.

In modern society, labor costs are increasing while the cost of specialized electronics is decreasing. It would be another advantage if a device could be provided for authentication and the like using electronics to reduce labor costs in performing the tasks.

Other advantages and features will appear hereinafter.

### SUMMARY OF THE INVENTION

The present invention provides an authenticating portable electronic device having radio frequency transmission capability, such as a cellular or wireless phone. The device has battery power, a display and a keypad. The device is fitted with a fingerprint reader proximate the keypad of the device for authenticating the user of the device and is not operable when others attempt to use it, thus guaranteeing the security of the device.

A receiver is part of device, for communicating authentication signals with a remote location to verify the identity of the user. The remote location can be a gate, door, or other moveable barrier, or it may be guard station where badges are normally inspected when approaching the station. In one embodiment, the device initiates communication with the remote location upon activation of said fingerprint reader. In an alternate embodiment, the remote location initiates communication with the device upon activation of said fingerprint reader. In either case, the device communicates with an RF inquiry at a remote location only when the fingerprint reader affirms the identity of the user.

The device includes a transmitter for sending signals to a transceiver receiver having a connection to a wire telephone system within a structure to permit phone calls using said device through the receiver to and from the wire telephone system. The device includes a connector for connecting to a docking cradle operably connected to a computer or other electronic device for authenticating the user before allowing access to the computer. The connector may be part of a battery charging interface, such as by using a USB connection to the computer or other electronic device.

### BRIEF DESCRIPTION OF THE DRAWINGS

For a more complete understanding of the invention, reference is hereby made to the drawings, in which:

FIG. 1 is a schematic block diagram showing an architecture for the device and system of the present invention.

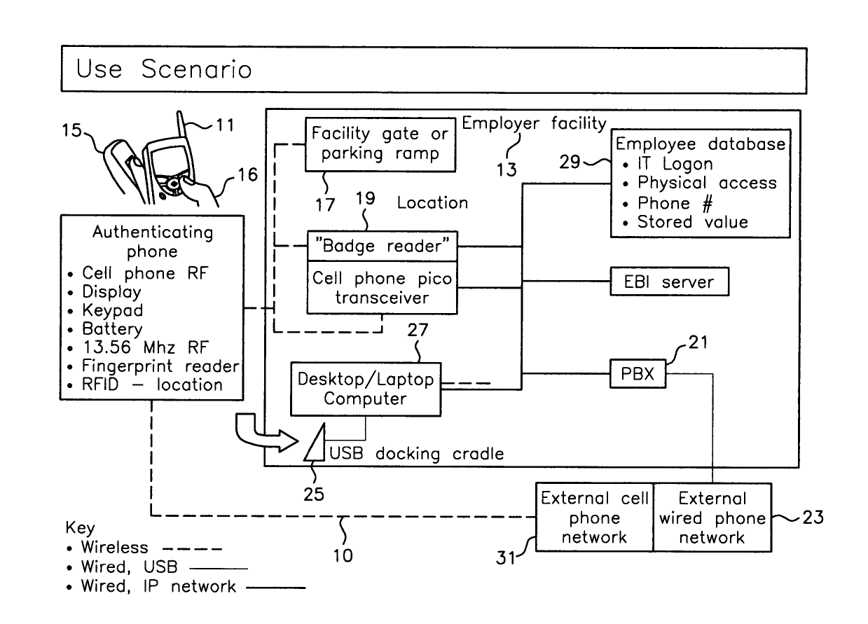

### DETAILED DESCRIPTION OF THE PREFERRED EMBODIMENT

Referring to the FIGURE, the system 10 generally includes an authenticating portable electronic device such as the cellular phone 11 which interacts with a location such as an employer facility 13. The preferred portable electronic device is a cellular phone 11, but could be any portable device that can transmit and receive a signal, such as a pager, PDA, and the like. The authenticating phone 11 shown in the FIGURE is a conventional radio frequency cellular phone, and has a display, keypad, battery and a connection for recharging the battery. Phone 11 also has a fingerprint reader 15, which is being accessed by the users finger 16. Phone 11 operates at a commonly used cell phone frequency and may include a 13.56 Mhz RF interface for emulating smart cards.

Employer facility 13 is shown for purposes of illustration as a typical corporate building with a need for security with respect to entry by employees and to asset management, such as proprietary information, PCs and laptops, and the like. Facility 13 could be, without limitation, a warehouse, a government building, a military facility or base, an airport, a school, a bank or other financial institution, or any facility where access is limited to designated personnel.

Typically the first use of the present invention would be when a person attempts to have access to the facility. A user will approach a gate, schematically shown at box 17, at which time the gate and the phone 11 detect each other via RF signals. The user places a finger on the fingerprint reader to provide biometric authentication. The phone accepts or verifies that the correct user for which the phone 11 has been programmed to recognize. The phone 11 exchanges cryptographically signed credentials with gate 11 over the wireless link. It should be noted that the phone may transmit or receive the signed credential signal, and alternately the gate 17 can transmit or receive the signal. At his point the gate is opened as the vehicle or user approaches.

In a typical scenario, the user parks the vehicle and approaches the front door of the facility. The authenticating phone 11 and a badge reader in schematic box 19 sense each other. Once again the user provides the required biometric data and the badge reader 19 opens the door. The badge reader 19 may also send time and attendance information to the employee database.

The user typically walks down the hall and may make a phone call while on the move. The call is passed through the local cell phone pico transceiver also located schematically in box 19, and routes the call through the PBX 21 and out through the wire telephone system illustrated as box 23. The user may not be charged for the call, depending on facility policy, because the call is handled by the PBX 21. The user may even no longer have a wired phone on the user's desk.

When the user gets to the desk where work or other activities take place, and inserts the phone 11 into the cradle 25, such as a USB docking cradle, which is connected to the desktop or laptop computer illustrated in box 27. Computers are illustrated in box 27 as an example of a typical work station, but any electronic device or other devices having an electronic component could be used. By way of example, box 27 could contain an instrument such as a gas chromatograph, or an x-ray machine, or military or government equipment, or any other such device. Once the phone 11 is inserted into cradle 25, the user provides the biometric, or fingerprint, and the cell phone 11 performs an automatic login for the user. This may involve the employee's database 29, such as the active directory, or it can be performed locally just between the computer 27 and the phone 11. The phone may optionally pass the user fingerprint data to the device (PC, badge reader, etc.) and allow the device to perform validation of the fingerprint. The cradle 25 can also hot syncs the PDA functions to the user's calendar. It also charges the battery in phone 11.

The user may leave the facility 13 and may need to make a phone call. The authenticating cell phone 11 connects to an external cell phone network shown in box 31 and the call occurs much like a typical cell phone call. The call is charged/billed through the cell phone provider the employee or user has subscribed to.

Some organizations have what is known as a building integration system, such as the system known as the Honeywell Enterprise Building Integration authenticator, which contains the security, access controls and building controls. Use of the present invention with such a system provides significant cost reduction by replacing human guards at a guard desk, for example, with the electronic badge reader described above. The present invention permits the integration of physical building controls with management of IT systems, and this invention would integrate the wireless phone system with the building PBX. This avoids duplicated efforts, such as requiring an EBI database and an IT database, and eliminates errors or confusion, or simply the need to update one database in view of new data in the other.

While particular embodiments of the present invention have been illustrated and described, they are merely exemplary and a person skilled in the art may make variations and modifications to the embodiments described herein without departing from the spirit and scope of the present invention. All such equivalent variations and modifications are intended to be included within the scope of this invention, and it is not intended to limit the invention, except as defined by the following claims.

1. In an authenticating portable electronic device having radio frequency transmission capability, battery power and a keypad, the improvement comprising:
a fingerprint reader proximate the keypad of said device for authenticating the user of said device;
a receiver and transmitter in said device for communicating authentication signals with a remote location to verify the identity of the user;
a transmitter/receiver for sending/receiving signals to a transceiver having a connection to a wire telephone system within a structure to permit phone calls using said device through the receiver to and from the wire telephone system; and
a connector for connecting to a docking cradle operably connected to a computer for authenticating the user before allowing access to said computer,

2. The device of claim 1, wherein portable electronic device is a cellular phone.

3. The device of claim 2, wherein said phone communicates with a RF inquiry at said remote location when said fingerprint reader affirms the identity of the user.

4. The device of claim 3, wherein said remote location is selected from gates, doors and moveable barriers.

5. The device of claim 3, wherein said device initiates said communication with said remote location.

6. The device of claim 3, wherein said remote location initiates said communication with said device triggering activation of said fingerprint reader.

7. The device of claim 1, wherein said electronic device includes a connector for connecting to a docking cradle operably connected to a computer for authenticating the user before allowing access to the computer.

8. The device of claim 7, wherein said connector is a battery charging interface.

9. In an authenticating portable electronic device having radio frequency transmission capability, battery power and a keypad, the improvement comprising:
fingerprint reader means for reading the finger print of a user and located proximate the keypad of said device for authenticating the user of said device;
receiver and transmitter means in said device for communicating authentication signals with a remote location to verify the identity of the user;
transciever means for sending signals to a transceiver having a connection to a wire telephone system within a structure to permit phone calls using said device through the receiver to and from the wire telephone system; and
connector means for connecting to a docking cradle operably connected to a computer for authenticating the user before allowing access to said computer,

10. The device of claim 9, wherein portable electronic device is a cellular phone.

11. The device of claim 10, wherein said phone communicates with a FR inquiry at said remote location when said fingerprint reader affirms the identity of the user.

12. The device of claim 11, wherein said remote location is selected from gates, doors and moveable barriers.

13. The device of claim 11, wherein said device initiates said communication with said remote location.

14. The device of claim 11, wherein said remote location initiates said communication with said device triggering activation of said fingerprint reader.

15. The device of claim 9, wherein said electronic device includes a connector for connecting to a docking cradle operably connected to a computer for authenticating the user before allowing access to the computer.

16. The device of claim 15, wherein said connector is a battery charging interface.

17. An authentication and communication system in a facility comprising:
a facility IT system having radio frequency transmission capability and a data base for storing data relating to personnel having access to and assets within the facility, said IT system further having a wire telephone system;
an authenticating portable electronic device having radio frequency transmission capability, battery power and a keypad, said electronic device including:
a fingerprint reader proximate the keypad of said device for authenticating the user of said device;
a transreceiver in said device for communicating authentication signals with a remote location to verify the identity of the user;
a transceiver for sending signals to a transceiver having a connection to a wire telephone system within a structure to permit phone calls using said device through the receiver to and from said wire telephone system;
a connector for connecting to a docking cradle operably connected to a computer for authenticating the user before allowing access to said computer,

18. The system of claim 17, wherein portable electronic device is a cellular phone.

19. The system of claim 18, wherein said phone communicates with a RF inquiry at said remote location only when said fingerprint reader affirms the identity of the user.

20. The system of claim 19, wherein said remote location is selected from gates, doors and moveable barriers.

21. The system of claim 19, wherein said device initiates said communication with said remote location.

22. The system of claim 19, wherein said remote location initiates said communication with said device triggering activation of said fingerprint reader.

23. The system of claim 17, wherein said electronic device includes a connector for connecting to a docking cradle operably connected to a computer for authenticating the user before allowing access to the computer.

24. The system of claim 23, wherein said connector is a battery charging interface.
